(19) United States
(12) Patent Application Publication
(10) Pub. No.: US 2015/0103761 A1
(43) Pub. Date: Apr. 16, 2015

(54) METHOD AND APPARATUS FOR RANDOM ACCESS IN A SYSTEM WHEREIN USER EQUIPMENT WITH DIFFERENT OPERATING BANDWIDTHS COEXIST

(71) Applicant: ALCATEL LUCENT, Paris (FR)

(72) Inventors: Yu Chen, Shanghai (CN); Sigen Ye, Murray Hill, NJ (US)

(73) Assignee: Alcatel Lucent, Boulogne Billancourt (FR)

(21) Appl. No.: 14/383,814

(22) PCT Filed: Mar. 4, 2013
(86) PCT No.: PCT/IB2013/000536

§ 371 Date: Sep. 8, 2014

(30) Foreign Application Priority Data
Mar. 9, 2012 (CN) 201210061073.2

(51) Int. Cl. H04W 74/08

(52) U.S. Cl. CPC H04W 74/0833
USPC 370/329

(57) ABSTRACT

A method and apparatus for random access are provided in the present invention. According to an embodiment of the present invention, a base station configures multiple preamble groups and configures at least one preamble for the respective preamble group according to a predetermined condition; broadcasts preamble configuration information to the respective user equipment, the preamble configuration information including the information associated with the respective preamble group; the user equipment selects the corresponding preamble group according to the received preamble configuration information and the communication bandwidth supported by the user equipment itself, and selects a preamble from the selected preamble group randomly and transmits it to the base station; the base station determines the communication bandwidth supported by the user equipment according to the received preamble; the base station proceeds the further communication with the user equipment within the communication bandwidth supported by the user equipment. Through the method, in the case of a wide system bandwidth, the communication of the narrow band user equipment can also be supported simply and efficiently, thus the application of the narrow band user equipment has been improved.

### FIELD OF THE INVENTION

The present invention relates to a communication system and, more particularly, to a method and apparatus for random access.

### BACKGROUND OF THE INVENTION

MTC (Machine Type Communication) is a newly introduced project in LTE system. Now many operators have shown great interest on MTC.

For the present 3GPP LTE system, the preamble is transmitted in the six resource blocks of the center band of the system bandwidth, thus a base station can receive the preambles from the respective user equipment without difficulty. However, for the message from the base station, for example, RAR (random access response), the communication bandwidth used to transmit this message has no limitation, thus the message may appear in anywhere of the whole system bandwidth, in addition, the base station does not know the communication bandwidth supported by the user equipment at this moment. In another aspect, the narrow band user equipment, for example, MTC user equipment only supports the limited communication bandwidth, such as 1.4 MHz. Thus, the narrow band user equipment may not receive the message from the base station, thereby cannot accomplish the access procedure. Therefore, in the case of the wide system bandwidth, how can the communication of the narrow band user equipment be supported simply and efficiently is a challenging problem.

### SUMMARY OF THE INVENTION

Thus, the defect exists in the prior art is that, the narrow band user equipment, for example, MTC user equipment, may not receive the message from the base station during the random access procedure, thereby cannot realize the access procedure.

In order to address the foregoing problems in the prior art, according to the first aspect of the invention, a method for proceeding random access in a base station is provided, wherein the user equipment is served by the base station, the method comprises the following steps: A. configuring multiple preamble groups and configuring at least one preamble for the respective preamble group according to a predetermined condition; B. broadcasting preamble configuration information to the respective user equipment, the preamble configuration information including the information associated with the respective preamble group; C. receiving a preamble from the user equipment; D. determining the communication bandwidth supported by the user equipment according to the received preamble; and E. proceeding the further communication with the user equipment within the communication bandwidth supported by the user equipment. Specifically, in step B, the information associated with the respective preamble group includes for example, how many preamble groups to which the base station has configured the preamble; which kinds of the communication bandwidth of the user equipment each preamble group is suitable for respectively; which preambles are in each preamble groups.

According to an embodiment of the present invention, the step A includes: configuring two preamble groups, which are used for wide band user equipments and narrow band user equipments respectively, and configuring at least one preamble for the respective preamble group according to a predetermined condition. Specifically, a base station can configure the preambles to two preamble groups, which are suitable for wide band user equipments and narrow band user equipments respectively, thereby the wide band user equipments and the narrow band user equipments can select the corresponding preamble group.

According to an embodiment of the present invention, the step A includes: configuring seven preamble groups, which are used for non-contention random access user equipments, 1.4 MHz user equipments, 3 MHz user equipments, 5 MHz user equipments, 10 MHz user equipments, 15 MHz user equipments and 20 MHz user equipments, and configuring at least one preamble for the respective preamble group according to a predetermined condition. Specifically, a base station can configure the preambles to seven preamble groups, which are suitable for the user equipments with the different communication bandwidth respectively, thereby different user equipments can the corresponding preamble group.

According to an embodiment of the present invention, the predetermined condition includes at least any one of the followings: the type of the user equipment in the coverage of the base station, the amount of the respective type of the user equipment, the communication requirement of the user equipment and system bandwidth. For example, when the amount of the 5 MHz user equipments in the coverage of the base station is considerable, the base station can configure more preambles for the preamble group used for the 5 MHz user equipments. When there is no 10 MHz user equipments in the coverage of the base station, the base station may not configure the preamble group used for the 10 MHz user equipments. Additionally, according to the current system bandwidth and the communication requirement for each user equipment, the base station may configure the preamble groups flexible to meet the specific demand.

According to the second aspect of the invention, a method for proceeding random access in a user equipment is provided, wherein the user equipment is served by a base station, the method comprises the following steps: a. receiving preamble configuration information from the base station, the preamble configuration information including the information associated with the respective preamble group; b. selecting the corresponding preamble group according to the received preamble configuration information and the communication bandwidth supported by the user equipment itself, and selecting a preamble from the selected preamble group randomly; c. transmitting the selected preamble to the base station; and d. proceeding the further communication with the base station within the communication bandwidth supported by the user equipment. Specifically, in step B, the information associated with the respective preamble group includes for example, how many preamble groups to which the base station has configured the preamble; which kinds of the communication bandwidth of the user equipment each preamble group is suitable for respectively; which preambles are in each preamble groups.

According to an embodiment of the present invention, there are two preamble groups, which are used for wide band user equipments and narrow band user equipments respectively, wherein each preamble group is configured with at least one preamble. Thereby, the wide band user equipments and the narrow band user equipments can select the corresponding preamble group respectively.

According to an embodiment of the present invention, there are seven preamble groups, which are used for non-contention random access user equipments, 1.4 MHz user equipments, 3 MHz user equipments, 5 MHz user equipments, 10 MHz user equipments, 15 MHz user equipments and 20 MHz user equipments, wherein each preamble group is configured with at least one preamble. Thereby, different user equipments can select the corresponding suitable preamble group respectively.

According to the third aspect of the invention, an apparatus for proceeding random access in a base station is provided, wherein the user equipment is served by the base station, the apparatus comprises: a configuring means, for configuring multiple preamble groups and configuring at least one preamble for the respective preamble group according to a predetermined condition; a broadcasting means, for broadcasting preamble configuration information to the respective user equipment, the preamble configuration information including the information associated with the respective preamble group; a first receiving means, for receiving a preamble from the user equipment; a determining means, for determining the communication bandwidth supported by the user equipment according to the received preamble; and a first communicating means, for proceeding the further communication with the user equipment within the communication bandwidth supported by the user equipment. Specifically, the information associated with the respective preamble group includes for example, how many preamble groups to which the base station has configured the preamble; which kinds of the communication bandwidth of the user equipment each preamble group is suitable for respectively; which preambles are in each preamble groups.

According to an embodiment of the present invention, the configuring means is used for configuring two preamble groups, which are used for wide band user equipments and narrow band user equipments respectively, and configuring at least one preamble for the respective preamble group according to a predetermined condition.

According to an embodiment of the present invention, the configuring means is used for configuring seven preamble groups, which are used for non-contention random access user equipments, 1.4 MHz user equipments, 3 MHz user equipments, 5 MHz user equipments, 10 MHz user equipments, 15 MHz user equipments and 20 MHz user equipments, and configuring at least one preamble for the respective preamble group according to a predetermined condition.

According to the fourth aspect of the present invention, an apparatus for proceeding random access in an user equipment is provided, wherein the user equipment is served by a base station, the apparatus comprises: a second receiving means, for receiving preamble configuration information from the base station, the preamble configuration information including the information associated with the respective preamble group; a selecting means, for selecting the corresponding preamble group according to the received preamble configuration information and the communication bandwidth supported by the user equipment itself, and selecting a preamble from the selected preamble group randomly; a transmitting means, for transmitting the selected preamble to the base station; and a second communicating means, for proceeding the further communication with the base station within the communication bandwidth supported by the user equipment.

Through the preferable embodiment of the present invention, in the case of the wide system bandwidth, the communication of the narrow band user equipments, for example, MTC user equipment, can be supported simply and efficiently, thus the application of the narrow band user equipment has been improved, which enables the narrow band user equipments to access the wide band system.

The respective aspect of the present invention will be more clarified though the description of the detailed embodiment in the following.

### BRIEF DESCRIPTION OF DRAWINGS

With reference to the detailed description to the applied preferable embodiments in conjunction with the figures, the above aims, advantages and features of the present invention will be more apparent, wherein:

FIG. 1 illustrates a flowchart of the random access method according to an embodiment of the present invention; and

FIG. 2 illustrates the block diagram of the apparatus for proceeding random access on the base station side and the user equipment side according to an embodiment of the present invention;

Wherein, same or similar reference numerals refer to same or similar apparatuses (modules) or step features.

### DETAILED DESCRIPTION OF EMBODIMENTS

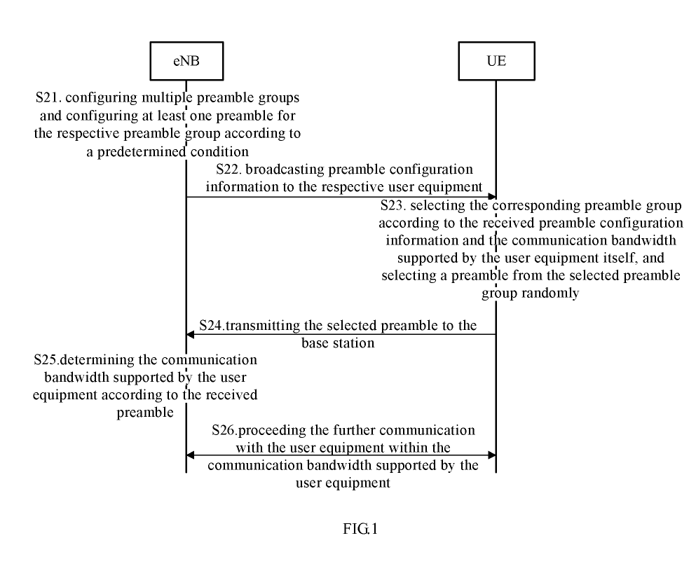

FIG. 1 illustrates a flowchart of the random access method according to an embodiment of the present invention.

As shown, in step S21, the base station configures multiple preamble groups and configures at least one preamble for the respective preamble group according to a predetermined condition.

Preferably, the base station could configure the preamble groups according to the type of the user equipment in the coverage of the base station and the amount of the respective type of the user equipment. For example, the base station may configure the preambles to two preamble groups, which are used for wide band user equipments and narrow band user equipments respectively. Further, the base station may configure the preambles to the preamble groups, which are used for non-contention random access user equipments, 1.4 MHz user equipments, 3 MHz user equipments, 5 MHz user equipments, 10 MHz user equipments, 15 MHz user equipments and 20 MHz user equipments.

When the amount of a certain type of an user equipment in the coverage of the base station is more or fewer, the base station could configure the preamble group used for this type of the user equipment correspondingly. For example, when the amount of 5 MHz user equipments in the coverage of the base station is considerable, the base station could configure more preambles for the preamble group used for the 5 MHz user equipment. However, when the amount of 10 MHz user equipments in the coverage of the base station is fewer, the base station could configure fewer preambles for the preamble group used for the 10 MHz user equipment.

Similarly, if there are no certain types of the user equipments in the coverage of the base station, for example, there are no 15 MHz user equipments in the coverage of the base station, the base station may not configure the preamble group used for this type of the user equipments. That is, based on the amount of a certain type of the user equipments in the coverage of the base station, the base station could determine the amount of the preamble in each preamble group.

Preferably, the base station could configure the preamble groups according to the current available system bandwidth. For example, if the system bandwidth could support 20 MHz user equipment, the base station could configure the preamble group used for 20 MHz user equipments. Preferably, the base station could configure the preamble group used for the non-contention random access user equipments according to the communication requirement of the respective user equipment.

It will be appreciated for those skilled in the art, that the configuration manner disclosed here is exemplary but not limited. According to the current situation, the base station could configure and adjust multiple preamble groups, and determine the amount of the preambles in each preamble group.

Next, in step S22, the base station broadcasts preamble configuration information to the respective user equipment, the preamble configuration information including the information associated with the respective preamble group. Thus, the user equipment could obtain the detail configuration of each preamble, for example, such as how many preamble groups to which the base station has configured the preamble; which kinds of the communication bandwidth of the user equipment each preamble group is suitable for respectively; which preambles are in each preamble groups. This broadcast step could be accomplished by using system information block for example.

In step S23, the user equipment selects the corresponding preamble group according to the received preamble configuration information and the communication bandwidth supported by the user equipment itself, and selecting a preamble from the selected preamble group randomly. For example, if the communication bandwidth supported by the user equipment is 1.4 MHz, the user equipment will select the preamble group used for the 1.4 MHz user equipments, and further select a preamble therefrom. If the communication bandwidth supported by the user equipment is 5 MHz, the user equipment will select the preamble group used for the 5 MHz user equipments, and further select a preamble therefrom.

In step S24, the user equipment transmits the selected preamble to the base station.

In step S25, the base station determines the communication bandwidth supported by the user equipment according to the received preamble. Specifically, for example, the base station receives the preamble from a 1.4 MHz user equipment, then the base station can detect which preamble group this preamble belongs to, thus the base station can determine the communication bandwidth supported by the user equipment.

Herein, as described in the background, all the preambles will be transmitted in the six resource blocks of the center band of the system bandwidth, thus a base station can receive the preambles from the respective user equipment without difficulty, including the preamble from the 1.4 MHz user equipments.

In step S26, the base station proceeds the further communication with the user equipment within the communication bandwidth supported by the user equipment. Specifically, for example, the base station has determined the communication bandwidth of the user equipment, for example, a MTC user equipment is 1.4 MHz, the base station will schedule the further messages, such RAR to this communication bandwidth, thereby the 1.4 MHz user equipment could receive the further message from the base station, thus the further communication with the base station could be implemented without difficulty.

In the following, the collision probability after the grouping of the preambles will be described:

The collision probability of RACH is given as follows:

$$P = 1 - {e}^{- λ} = 1 - {e}^{- \frac{M / T / g}{N ( 64 - n ) / g}} = 1 - {e}^{- \frac{M / T}{N ( 64 - n )}}$$

Wherein, λ is the access intensity, M is the total number of the user equipments, T is the arrival duration for testing, g is the number of the preambles in a specific preamble group, N is the configured number of the subframes pro second, n is the number of the preambles used for non-contention random access. It can be seen, the collision probability has not been changed after the grouping of the preambles. Even at the arrival rate of 3000 user equipments in 10 s, there are only 6 user equipments arrived at the same time, thus the number of the preambles is sufficient. Besides, with some distribution method, e.g. EAB, the number of the user equipments will be further reduced.

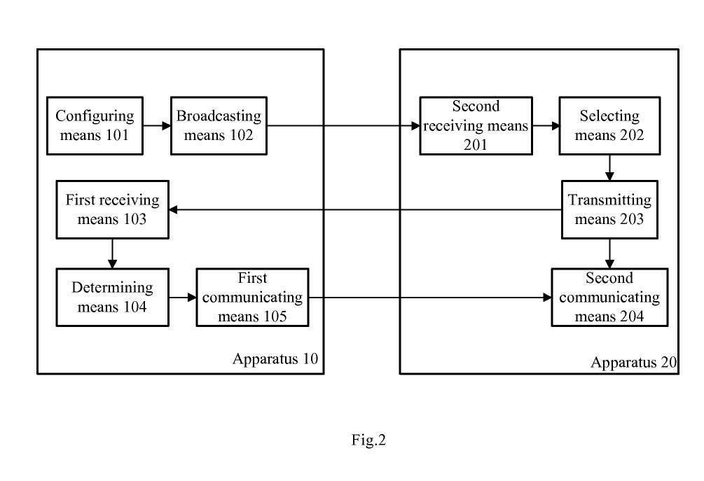

FIG. 2 illustrates the block diagram of the apparatus for proceeding random access on the base station side and the user equipment side according to an embodiment of the present invention.

As shown, in the apparatus 10 for proceeding random access on the base station side, the configuring means 101 is used for configuring multiple preamble groups and configuring at least one preamble for the respective preamble group according to a predetermined condition. The broadcasting means 102 is used for broadcasting preamble configuration information to the respective user equipment, the preamble configuration information including the information associated with the respective preamble group. The first receiving means 103 is used for receiving a preamble from the user equipment. The determining means 104 is used for determining the communication bandwidth supported by the user equipment according to the received preamble. And the first communicating means 105 is used for proceeding the further communication with the user equipment within the communication bandwidth supported by the user equipment.

Preferably, the configuring means 101 is used for configuring two preamble groups, which are used for wide band user equipments and narrow band user equipments respectively, and configuring at least one preamble for the respective preamble group according to a predetermined condition.

Preferably, the configuring means 101 is used for configuring seven preamble groups, which are used for non-contention random access user equipments, 1.4 MHz user equipments, 3 MHz user equipments, 5 MHz user equipments, 10 MHz user equipments, 15 MHz user equipments and 20 MHz user equipments, and configuring at least one preamble for the respective preamble group according to a predetermined condition.

Preferably, the predetermined condition includes at least any one of the followings: the type of the user equipment in the coverage of the base station, the amount of the respective type of the user equipment, the communication requirement of the user equipment and system bandwidth.

In the apparatus 20 for proceeding random access on the user equipment side, the second receiving means 201 is used for receiving preamble configuration information from the base station, the preamble configuration information including the information associated with the respective preamble group. The selecting means 202 is used for selecting the corresponding preamble group according to the received preamble configuration information and the communication bandwidth supported by the user equipment itself, and selecting a preamble from the selected preamble group randomly. The transmitting means 203 is used for transmitting the selected preamble to the base station. The second communicating means 204 is used for proceeding the further communication with the base station within the communication bandwidth supported by the user equipment.

It is appreciated for those skilled in the art that, the embodiments described above are exemplary but not limited. Different technology features appearing in different embodiments can be combined so as to implement beneficial effects. Based on the research of the drawings, specification and claims, it is intelligible to those skilled in the art that, the alternative embodiments of these disclosed embodiments could be implemented. In the claims, term “include” doesn't exclude other equipments or steps; an indefinite article “a” doesn't exclude multiple; terms “first” and “second” are used to indicate name other than any specific order. Any drawings indicator in the claims should not be understood as the limitation to the protection scope. The function of multiple parts appearing in the claims can be implemented by a single hardware or software. Certain technology features appearing in the different subordinate claims don't mean that these technology features cannot be combined so as to acquire beneficial effects.

1. A method for proceeding random access in a base station, wherein the user equipment is served by the base station, the method comprises:
configuring multiple preamble groups and configuring at least one preamble for the respective preamble group according to a predetermined condition;
broadcasting preamble configuration information to the respective user equipment, the preamble configuration information including the information associated with the respective preamble group;
receiving a preamble from the user equipment;
determining the communication bandwidth supported by the user equipment according to the received preamble; and
proceeding the further communication with the user equipment within the communication bandwidth supported by the user equipment.

2. A method according to claim 1, wherein the configuring includes:
configuring two preamble groups, which are used for wide band user equipments and narrow band user equipments respectively, and configuring at least one preamble for the respective preamble group according to a predetermined condition.

3. A method according to claim 1, wherein the configuring includes:
configuring seven preamble groups, which are used for non-contention random access user equipments, 1.4 MHz user equipments, 3 MHz user equipments, 5 MHz user equipments, 10 MHz user equipments, 15 MHz user equipments and 20 MHz user equipments, and configuring at least one preamble for the respective preamble group according to a predetermined condition.

4. A method according to claim 1, wherein the predetermined condition includes at least any one of the followings: the type of the user equipment in the coverage of the base station, the amount of the respective type of the user equipment, the communication requirement of the user equipment and system bandwidth.

5. A method for proceeding random access in a user equipment, wherein the user equipment is served by a base station, the method comprises:
receiving preamble configuration information from the base station, the preamble configuration information including the information associated with the respective preamble group;
selecting the corresponding preamble group according to the received preamble configuration information and the communication bandwidth supported by the user equipment itself, and selecting a preamble from the selected preamble group randomly;
transmitting the selected preamble to the base station; and
proceeding the further communication with the base station within the communication bandwidth supported by the user equipment.

6. A method according to claim 5, wherein there are two preamble groups, which are used for wide band user equipments and narrow band user equipments respectively, wherein each preamble group is configured with at least one preamble.

7. A method according to claim 5, wherein there are seven preamble groups, which are used for non-contention random access user equipments, 1.4 MHz user equipments, 3 MHz user equipments, 5 MHz user equipments, 10 MHz user equipments, 15 MHz user equipments and 20 MHz user equipments, wherein each preamble group is configured with at least one preamble.

8. An apparatus for proceeding random access in a base station, wherein the user equipment is served by the base station, the apparatus comprises:
a configuring means, for configuring multiple preamble groups and configuring at least one preamble for the respective preamble group according to a predetermined condition;
a broadcasting means, for broadcasting preamble configuration information to the respective user equipment, the preamble configuration information including the information associated with the respective preamble group;
a first receiving means, for receiving a preamble from the user equipment;
a determining means, for determining the communication bandwidth supported by the user equipment according to the received preamble; and
a first communicating means, for proceeding the further communication with the user equipment within the communication bandwidth supported by the user equipment.

9. An apparatus according to claim 8, wherein the configuring means is used for configuring two preamble groups, which are used for wide band user equipments and narrow band user equipments respectively, and configuring at least one preamble for the respective preamble group according to a predetermined condition.

10. An apparatus according to claim 8, wherein the configuring means is used for configuring seven preamble groups, which are used for non-contention random access user equipments, 1.4 MHz user equipments, 3 MHz user equipments, 5 MHz user equipments, 10 MHz user equipments, 15 MHz user equipments and 20 MHz user equipments, and configuring at least one preamble for the respective preamble group according to a predetermined condition.

11. An apparatus according to claim 8, wherein the predetermined condition includes at least any one of the following: the type of the user equipment in the coverage of the base station, the amount of the respective type of the user equipment, the communication requirement of the user equipment and system bandwidth.

12. An apparatus for proceeding random access in an user equipment, wherein the user equipment is served by a base station, the apparatus comprises:
a second receiving means, for receiving preamble configuration information from the base station, the preamble configuration information including the information associated with the respective preamble group;
a selecting means, for selecting the corresponding preamble group according to the received preamble configuration information and the communication bandwidth supported by the user equipment itself, and selecting a preamble from the selected preamble group randomly;
a transmitting means, for transmitting the selected preamble to the base station; and
a second communicating means, for proceeding the further communication with the base station within the communication bandwidth supported by the user equipment.

13. An apparatus according to claim 12, wherein there are two preamble groups, which are used for wide band user equipments and narrow band user equipments respectively, wherein each preamble group is configured with at least one preamble.

14. An apparatus according to claim 12, wherein there are seven preamble groups, which are used for non-contention random access user equipments, 1.4 MHz user equipments, 3 MHz user equipments, 5 MHz user equipments, 10 MHz user equipments, 15 MHz user equipments and 20 MHz user equipments, wherein each preamble group is configured with at least one preamble.
